(19) United States
(12) Patent Application Publication
(10) Pub. No.: US 2012/0191846 A1
(43) Pub. Date: Jul. 26, 2012

(54) MONITORING SYSTEM, MONITORING APPARATUS, MONITORING METHOD AND MONITORING PROGRAM

(76) Inventor: YUI IKUMA, Tokyo (JP)

(21) Appl. No.: 13/351,413

(22) Filed: Jan. 17, 2012

(30) Foreign Application Priority Data
Jan. 21, 2011 (JP) 11106/2011

(51) Int. Cl. G06F 15/173

(52) U.S. Cl. 709/224

(57) ABSTRACT

A monitoring system, includes a monitoring apparatus which monitors a monitored object equipment; and a managing server which manage a result of the monitoring apparatus monitoring the monitored object equipment, wherein the monitoring apparatus includes an information acquiring unit to acquire connection information, which is used for connecting with the managing server, from an information storing medium which stores the connection information, wherein in the case that the information acquiring unit acquires the connection information from the information storing medium, the monitoring apparatus connects with the managing server on the basis of the connection information to communicate with the managing server, and then sends the monitoring result to the managing server, and wherein the managing server acquires the monitoring result while the communication connection with the monitoring apparatus is maintained.

### INCORPORATION BY REFERENCE

This application is based upon and claims the benefit of priority from Japanese Patent Application No. JP 2011-011106, filed on Jan. 21, 2011, the disclosure of which is incorporated herein in its entirety by reference.

### BACKGROUND OF THE INVENTION

1. Technical Field

The present invention relates to a monitoring system which monitors equipment installed in a household, and an equipment installed in various plants such as an electric power supply facility, a water and sewerage managing facility, a darn, a building and a factory.

2. Background Art

In recent years, a wide area information network becomes progressed rapidly. In the state mentioned above, it is anticipated that the above-mentioned monitoring system will be built in a wide area and monitored objects (for example, a lighting equipment, an air conditioning equipment, a general electrical home appliance and a distributed type power supply) will become increasing. The monitoring system includes, for example, a monitoring apparatus to monitor the monitored object which is installed in the various plants, a managing server to manage a result of the monitoring apparatus monitoring the monitored object, and the like. An example of the monitoring system is disclosed in Japanese Patent Application Laid-Open No. 1987-118496 (patent document 1), Japanese Patent Application Laid-Open No. 1997-322276 (patent document 2) and Japanese Patent Application Laid-Open No. 2007-329811 (patent document 3).

In the case that the monitored objects become increasing as the monitoring system becomes widened as mentioned above, it is inevitable that the monitoring apparatuses, which monitor the monitored objects, become increasing. Meanwhile, in order to communicate with the managing server, it is necessary for the monitoring apparatus to carry out communication setting such as setting of a connection destination. Usually, each manufacturer of the monitoring apparatus carries out the communication setting for each monitoring apparatus according to an user of the monitoring apparatus and an installation site of the monitoring apparatus, and afterward the manufacturer ships the monitoring apparatus. Moreover, after the monitoring apparatus is installed, a maintenance service provider goes to the installation site of the monitoring apparatus to change the communication setting of the monitoring apparatus by use of a tool for maintenance.

### SUMMARY

The present invention is conceived in consideration of the circumstance mentioned above. An object of the present invention is to provide an art which enables the monitoring apparatus to connect easily to a destination with no necessity of setting any connection destination inside the monitoring apparatus.

A monitoring system, includes a monitoring apparatus which monitors a monitored object equipment; and a managing server which manage a result of the monitoring apparatus monitoring the monitored object equipment, wherein the monitoring apparatus includes an information acquiring unit to acquire connection information, which is used for connecting with the managing server, from an information storing medium which stores the connection information, wherein in the case that the information acquiring unit acquires the connection information from the information storing medium, the monitoring apparatus connects with the managing server on the basis of the connection information to communicate with the managing server, and then sends the monitoring result to the managing server, and wherein the managing server acquires the monitoring result while the communication connection with the monitoring apparatus is maintained.

A monitoring method to monitor a monitored object equipment by use of a system which includes a monitoring apparatus to monitor the monitored object equipment, and a managing server to manage a result of the monitoring apparatus monitoring the monitored object equipment, includes acquiring by the monitoring apparatus connection information, which is used for connecting with the managing server, from an information storing medium which stores the connection information; connecting by the monitoring apparatus with the managing server on the basis of the connection information to communicate with the managing server, in the case that the information acquiring unit acquires the connection information from the information storing medium, and sending by the monitoring apparatus the monitoring result to the managing server; and acquiring by the managing server the monitoring result while the communication connection between the managing server and the monitoring apparatus is maintained.

A program, which is applied to a system including a monitoring apparatus to monitor a monitored object equipment, and a managing server to manage a result of the monitoring apparatus monitoring the monitored object equipment, and which is used for monitoring the monitored object equipment, carries out, includes acquiring by the monitoring apparatus connection information, which is used for connecting with the managing server, from an information storing medium which stores the connection information; connecting by the monitoring apparatus with the managing server on the basis of the connection information to communicate with the managing server, in the case that the information acquiring unit acquires the connection information from the information storing medium, and sending by the monitoring apparatus the monitoring result to the managing server; and acquiring by the managing server the monitoring result while the communication connection between the managing server and the monitoring apparatus is maintained.

### BRIEF DESCRIPTION OF THE DRAWINGS

Exemplary features and advantages of the present invention will become apparent from the following detailed description when taken with the accompanying drawings in which:

FIG. 1 shows a configuration of a monitoring system according to a first exemplary embodiment of the present invention;

FIG. 2 shows structure of a user managing unit;

FIG. 3 is an explanatory diagram showing an operation of the monitoring system according to the first exemplary embodiment of the present invention;

FIG. 4 shows a configuration of a monitoring system according to a second exemplary embodiment of the present invention;

FIG. 5 shows an example of structure of a user managing table;

FIG. 6 is an explanatory diagram showing an operation of the monitoring system according to the second exemplary embodiment of the present invention;

FIG. 7 is an explanatory diagram showing a start notifying packet;

FIG. 8 shows a configuration of a monitoring system according to a third exemplary embodiment of the present invention; and

FIG. 9 shows a configuration with which an user of a monitoring control apparatus checks a management state which is managed by a managing server.

### EXEMPLARY EMBODIMENT

Exemplary embodiments of the present invention will now be described in detail in accordance with the accompanying drawings.

### First Exemplary Embodiment

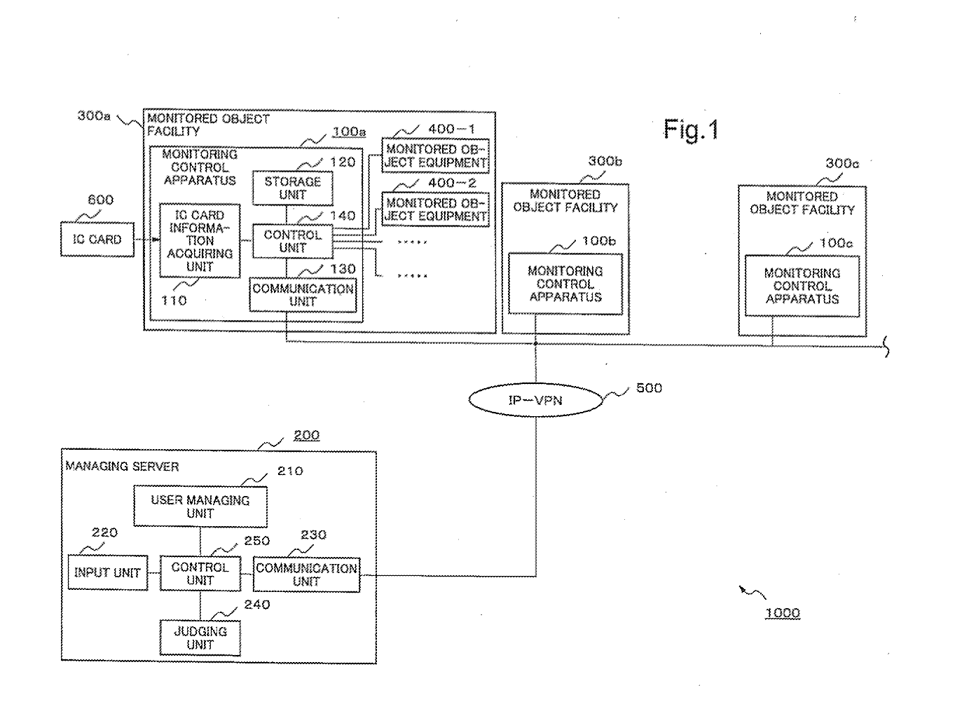

FIG. 1 shows a configuration of a monitoring system according to a first exemplary embodiment of the present invention. As shown in FIG. 1, a monitoring system 1000 includes monitoring control apparatuses 100a, 100b and 100c, and a managing server 200. The monitoring control apparatuses 100a, 100b and 100c are corresponding to a monitoring apparatus according to the present invention. The monitoring control apparatuses 100a, 100b and 100c are installed in monitored object facilities 300a, 300b and 300c respectively. The monitoring control apparatus 100a monitors monitored object equipments 400-1, 400-2, 400-3 and the like. Similarly, the monitoring control apparatuses 100b and 100c also monitor one or a plurality of the monitored object equipments.

Here, the monitoring control apparatuses 100a, 100b and 100c are collectively called as a monitoring control apparatus 100 in the following description as far as it is not necessary to identify and to explain each of the monitoring control apparatuses 100a, 100b and 100c in particular. Similarly, the monitored object facilities 300a, 300b and 300c are collectively called as a monitored object facility 300. Moreover, the monitored object equipments 400-1, 400-2, 400-3 and the like are collectively called as a monitored object equipment 400.

The monitoring control apparatus 100 and the managing server 200 are connected each other, for example, through IP-VPN (IP Virtual Private Network) in order to communicate each other. Here, IP-VPN means a virtual private communication network built over a wide area IP communication network which a communication carrier holds. It may be preferable that the monitoring control apparatuses 100a, 100b and 100c, and the control server 200 are connected each other through a communication network other than IP-VPN (for example, LAN (Local Area Network)) in order to communicate each other.

Here, the monitoring system 1000 monitors the monitored object equipment 400 which is installed in the monitored object facility 300. The monitored object facility 300 is, for example, a household, various plants such as an electric power supply facility, a water and sewerage managing facility, a dam, a building and a factory, or the like.

The monitored object equipment 400, which is installed in the monitored object facility 300, is, for example, an electric power generating equipment (solar panel or the like), a lighting equipment (desk lamp), an air-conditioning equipment (air conditioner), a general electrical home appliances, a distributed type power supply or the like.

The monitoring control apparatus 100 monitors, for example, electric power consumption and operation efficiency of the monitored object equipment 400 and sends a monitoring result to the managing server 200 through IP-VPN 500. For example, a smart meter and a high-performance power conditioner, which are installed in a household, are applicable to the monitoring control apparatus 100. The managing server 200 acquires the monitoring result which is sent by the monitoring control apparatus 100, and carries out control based on the monitoring result.

Next, a configuration of the monitoring control apparatus 100 will be described. As shown in FIG. 1, the monitoring control apparatus 100 includes an IC card information acquiring unit 110, a storage unit 120, a communication unit 130 and a control unit 140.

An IC card 600 can be attached to the IC card information acquiring unit 110. The IC card 600 stores, at least, connection information (for example, an IP address and a node ID of the managing server 200) for connection with the managing server 200. It may be preferable that the IC card 600 stores an user identifier for identifying an user of the monitoring control apparatus 100 in addition to the connection information. Any user identifier can be set through an operator of the monitoring system 1000 or a manager of the managing server 200 carrying out randomization and encryption. The user identifier is stored also in the managing server 200 as mentioned later. Here, the IC card 600 is corresponding to an information storing medium according to the present invention. It may be preferable that, for example, CD, CVD, a flash memory, and portable HDD are used as the information storing medium in place of the IC card 600. The user identifier is corresponding to an identification information according to the present invention.

When the IC card 600 is attached to the IC card information acquiring unit 110, the IC card information acquiring unit 110 acquires various information which is stored in the IC card 600. That is, if the connection information is stored in the IC card 600, the IC card information acquiring unit 110 acquires the connection information. If the connection information and the user identifier are stored in the IC card 600, the IC card information acquiring unit 110 acquires the connection information and the user identifier.

The storage unit 120 stores information which is necessary in various processes carried out by the monitoring control apparatus 100. However, the storage unit 120 does not store the connection information, which is requested to be set for each monitoring control apparatus 100, at a time of product shipment.

The communication unit 130 is connected with IP-VPN 500 to communicate with the managing server 200 through IP-VPN 500 under control of the control unit 140.

The control unit 140 controls a whole of the monitoring control apparatus 100. The control unit 140, which is connected with the monitored object equipment 400, monitors the monitored object equipment 400. In the case that the IC card information acquiring unit 110 acquires the connection information (it is assumed that the connection information is, for example, an IP address of the managing server 200), the control unit 140 connects with the managing server 200 via the communication unit 130 on the basis of the acquired IP address of the managing server 200 in order to communicate with the managing server 200. Moreover, in the case that the IC card 600 stores the connection information and the user identifier, the control unit 140 acquires the IP address (connection information) of the managing server 200 which is corresponding to a destination of the connection, and the user identifier, when the IC card information acquiring unit 110 acquires the connection information and the user identifier. In this case, the control unit 140 connects with the managing server 200 via the communication unit 130 on the basis of the acquired IP address of the managing server 200 in order to communicate with the managing server 200, and then the control unit 140 sends the user identifier to the managing server 200.

Moreover, the control unit 140 acquires a result of monitoring the monitored object equipment 400 (for example, the electric power consumption and the operation efficiency of the monitored object equipment 400). While the communication connection between the monitoring control apparatus 100 and the managing server 200 is maintained, the control unit 140 sends the result of monitoring the monitored object equipment 400 to the managing server 200.

Next, a configuration of the managing server 200 will be described specifically. The managing server 200 includes an user managing unit 210, an input unit 220, a communication unit 230, a judging unit 240 and a control unit 250. Here, while the managing server 200 has been described as one apparatus, it may be preferable that the user managing unit 210 is defined separately as an user managing server, and the communication unit 230 is defined separately as an upper apparatus, and other constituents including the control unit 250 are defined separately as an upper system.

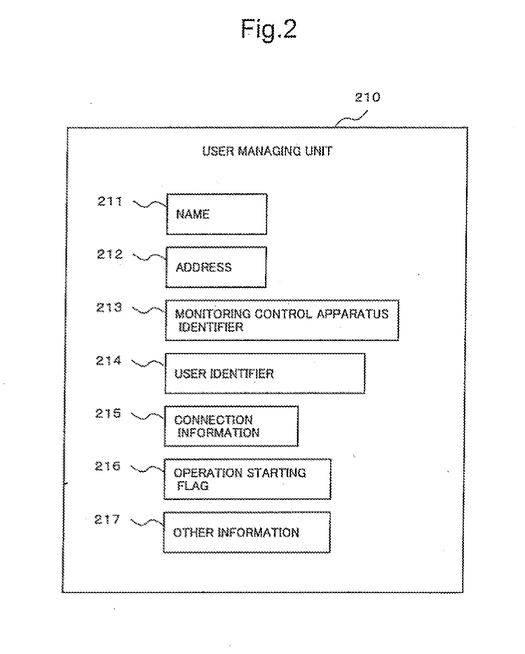

FIG. 2 shows structure of the user managing unit 210. The user managing unit 210 stores a name 211 of the user of the monitoring system 1000, an address 212, a monitoring control apparatus identifier 213 which the user can use, an user identifier 214, connection information 215, an operation starting flag 216 and other information 217. These information 211 to 217 are stored in the user managing unit 200 in association with the user. Here, the user managing unit 210 is corresponding to an user managing table according to the present invention.

Moreover, the monitoring control apparatus identifier 213 is serial number which is assigned for each monitoring control apparatus 100. The monitoring control apparatus identifier 213 can be set beforehand by the user and a set-upper of the monitoring control apparatus 100 in advance. Since the monitoring control apparatus identifier 213 can be set by a specific person with no restriction as mentioned above, it is possible to use the monitoring control apparatus identifier 213 as a password. The user and the set-upper of the monitoring control apparatus 100 set the monitoring control apparatus identifier 213 optionally and notify the manager of the managing server 200 of the monitoring control apparatus identifier 213 in advance. As a result, the managing server 200 can make the monitoring control apparatus identifier 213 stored in the user managing unit 210.

The operator of the monitoring system 1000 and the manager of the managing server 200 can set the user identifier 214 through carrying out randomization and encryption. It may be preferable that the operator of the monitoring system 1000 and the manager of the managing server 200 make the user identifier 214 stored in the IC card 600. The managing server 200 manages the user of the monitoring control apparatus 100 by use of the user identifier 214.

As mentioned above, the connection information 215 is, for example, an IP address and a node ID of a destination such as the managing server 200 with which the user can connect. The connection information is copied and stored in the IC card 600 which is dedicated for each user.

The operation starting flag 216 is used to switch an operation state between an ON state in which it is possible to acquire the result of monitoring the monitored object equipment 400 from the monitoring control apparatus 100, and an OFF state in which it is impossible to acquire the result of monitoring the monitored object equipment 400 from the monitoring control apparatus 100.

The other information 217 includes information which is not related directly to the setting of the monitoring control apparatus 100. The other information 217 includes, for example, information on an operation starting day, contact information on user, information on kind of possessed home appliance, an amount of generated electric power of the distributed type power supply and an amount of charge. The other information 217 is used to provide a higher service when the managing server 200 controls the monitoring control apparatus 100.

The input unit 220 includes a keyboard or the like. The manager of the managing server 200 inputs, for example, various information 211 to 217, which are stored afterward in the user managing unit 210, by use of the input unit 220.

The communication unit 230, which connects with IP-VPN 500, communicates with the monitoring control apparatus 100 or the like through IP-VPN 500.

The judging unit 240 judges whether the user identifier, which is sent from the monitoring control apparatus 100, exists in the user identifiers 214 stored in the user managing unit 210. Here, the user identifier 214 is corresponding to information on an user who is permitted to connect to the managing server 200 among the users of the monitoring control apparatus 100. The user identifier 214 is corresponding to connection permission identifying information according to the present invention.

The control unit 250 controls a whole of the managing server 200. The control unit 250 classifies the various information inputted by the input unit 220, and stores these information in the user managing unit 210. Moreover, the control unit 250 acquires the monitoring result which is sent by the monitoring control apparatus 100. In the case that the control unit 250 receives the user identifier from the monitoring control apparatus 100, the control unit 250 acquires the monitoring result, which is sent by the monitoring control apparatus 100, on the basis of a judgment of the judging unit 240. Here, the monitoring result is corresponding to the result of monitoring the monitored object equipment 400 (for example, the electric power consumption and the operation efficiency) as mentioned above.

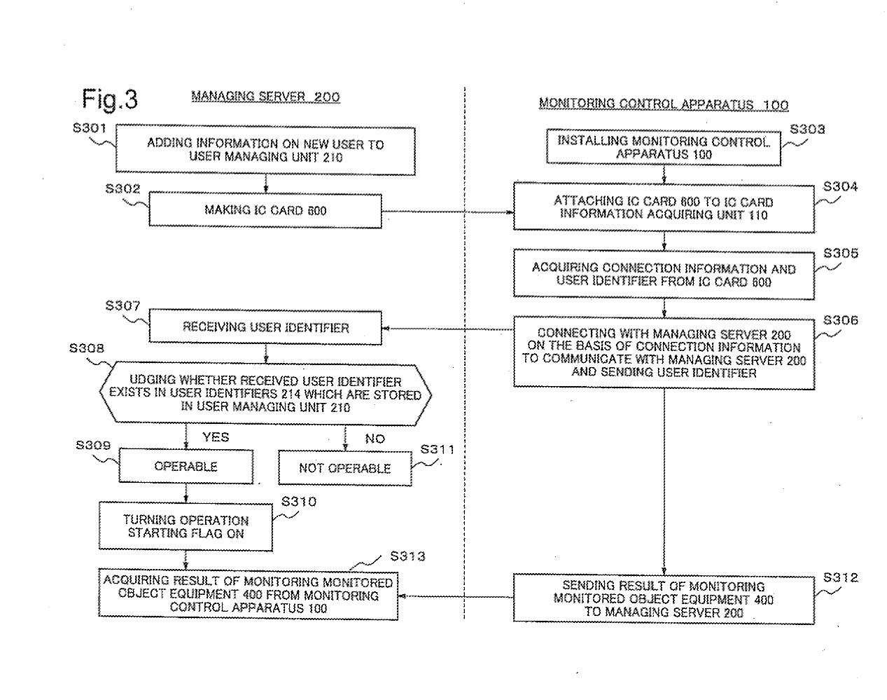

Next, an operation of the monitoring system according to the first exemplary embodiment of the present invention will be described. FIG. 3 is an explanatory diagram showing the operation of the monitoring system according to the first exemplary embodiment of the present invention.

Here, a case that a new monitoring control apparatus 100 is set up is assumed. First, the managing server 200 acquires information on a new user of the monitoring control apparatus 100 which is set up newly, and adds the information to the user managing unit 210 by use of the input unit 220, and updates information on the user (S301). Next, the manager of the managing server 200 makes the IC card 600 on the basis of the information which is stored in the user managing unit 210 (S302). The connection information 215 and the user identifier 214, which are corresponding to the new user, are recorded in the IC card 600. The IC card 600 is delivered to the user of the monitoring control apparatus 100, for example, by the operator of the monitoring system 1000 or the manager of the managing server 200.

Meanwhile, the user sets up the monitoring control apparatus 100 in the monitored object facility 300 and connects the monitored object equipment 400 with the monitoring control apparatus 100 (S303). When the user attaches the IC card 600 to the IC card information acquiring unit 110 (S304), the IC card information acquiring unit 110 acquires the connection information and the user identifier from the IC card 600 (S305).

Next, the communication unit 130 of the monitoring control apparatus 100 connects with the managing server 200 through IP-VPN 500 on the basis of the connection information to communicate with the managing server 200, and sends the user identifier, which is stored in the IC card 600, to the managing server 200 (S306).

When the communication unit 230 of the managing server 200 receives the user identifier from the monitoring control apparatus 100 (S307), the judging unit 240 of the managing server 200 judges whether the received user identifier exists in the user identifiers 214 (connection permission identifying information) which are stored in the user managing unit 210 (S308). In the case that the received user identifier exists in the connection permission identifying information (YES in S308), the control unit 250 of the managing server 200 judges to be operable (S309), and sets the operation starting flag 216 to the ON state (S310). On the other hand, in the case that the received user identifier does not exist in the connection permission identifying information (NO in S308), the control unit 250 of the managing server 200 judges to be not operable (S311), and does not carry out any process afterward. In this case, it may be preferable that the managing server 200 notifies the monitoring control apparatus 100 of the monitoring system 1000 being not operable.

When the communication unit 130 of the monitoring control apparatus 100 sends the result of monitoring the monitored object equipment 400 to the managing server 200 (S312) while the operation starting flag 216 is turned ON, the control unit 250 of the managing server 200 acquires the monitoring result via the communication unit 230 (S313). As mentioned above, the managing server 200 can acquire the result of the monitoring control apparatus 100 monitoring the monitored object equipment 400.

While it is exemplified in FIG. 2 that the IC card 600 stores the connection information and the user identifier, it may be preferable that the IC card 600 stores only the connection information and does not store the user identifier. In this case, the IC card information acquiring unit 110 acquires only the connection information from the IC card 600 in place of the processes S305 and 5306 shown in FIG. 3. Then, the communication unit 130 of the monitoring control apparatus 100 connects with the managing server 200 on the basis of the connection information to communicate with the managing server 200, and sends the result of monitoring the monitored object equipment 400 to the managing server 200. The managing server 200 acquires the result of monitoring the monitored object equipment 400 from the monitoring control apparatus 100. At this time, since the managing server 200 does not carry out the process of S308 shown in FIG. 3, the managing server 200 does not make the judging unit 240 work.

As mentioned above, the monitoring system 1000 according to the first exemplary embodiment of the present invention includes the monitoring control apparatus 100 and the managing server 200. The monitoring control apparatus 100 monitors the monitored object equipment 400. The managing server 200 manages the result of the monitoring control apparatus 100 monitoring the monitored object equipment 400. The monitoring control apparatus 100 includes the IC card information acquiring unit 110. The IC card information acquiring unit 110 acquires the connection information, which is used for connecting with the managing server 200, from the IC card 600 which stores the connection information. In the case that the IC card information acquiring unit 110 acquires the connection information from the IC card 600, the monitoring control apparatus 100 connects with the managing server 200 on the basis of the connection information to communicate with the managing server 200, and sends the monitoring result to the managing server 200. Then, the managing server 200 acquires the monitoring result while the communication connection is maintained.

As mentioned above, the monitoring control apparatus 100 can read and acquire the connection information easily from the IC card 600 with no necessity of holding internally the connection information which is used for connecting with the managing server 200. For this reason, according to the art of the present invention, it is possible to connect the monitoring control apparatus 100 easily with the destination with no necessity of setting the destination inside the monitoring control apparatus 100. Moreover, since it is possible to acquire the connection information only through attaching the IC card 600 to the IC card information acquiring unit 110, it is unnecessary that a manufacturer, a dealer or an user sets the connection information for each monitoring control apparatus 100 at a time of production or setting of the monitoring control apparatus 100. As a result, it is possible to reduce the work load. Similarly, with regard to the maintenance operation after setting up the monitoring control apparatus 100, it is unnecessary to re-set the connection information for each monitoring control apparatus 100. As a result, it is possible to reduce the work load. Moreover, only the user identifier and the connection information among information on the user are stored in the IC card 600, and all other information is managed by the managing server 200. As a result, even if the IC card 600 is lost, it is possible to prevent important information on the user (for example, name, address, or the like) from leaking.

According to the monitoring system 1000 of the first exemplary embodiment of the present invention, the IC card 600 stores the user identifier, which identifies the user of the monitoring control apparatus 100, in addition to the connection information. Moreover, the managing server 200 includes the user table (user managing unit 210) and the judging unit 240. The user table (user managing unit 210) stores beforehand the connection permission identifying information (user identifier 214) which is information on the user who is permitted to connect with the managing server 200 among the users of the monitoring control apparatus 100. The judging unit 240 judges whether the identification information, which is sent by the monitoring control apparatus 100, exists in the connection permission identifying information (user identifier 214). In the case that the judging unit 240 that the identification information exists in the connection permission identifying information (user identifier 214), the managing server 200 acquires the monitoring result.

As mentioned above, the judging unit 240 judges whether the user identifier, which is stored in the IC card 600, exists in the connection permission identifying information (user identifier 214) which is stored in the user table (user managing unit 210) of the managing server 200 in advance, and afterward the managing server 200 acquires the monitoring result which is sent by the monitoring control apparatus 100. For this reason, in addition to the effect mentioned above, the managing server 200 can acquire surely the monitoring result which is sent by the monitoring control apparatus 100 of the user who is permitted to connect with the managing server 200. Moreover, the managing server 200 can restrict an access from the user who is not permitted to connect with the managing server 200.

### Second Exemplary Embodiment of the Present Invention

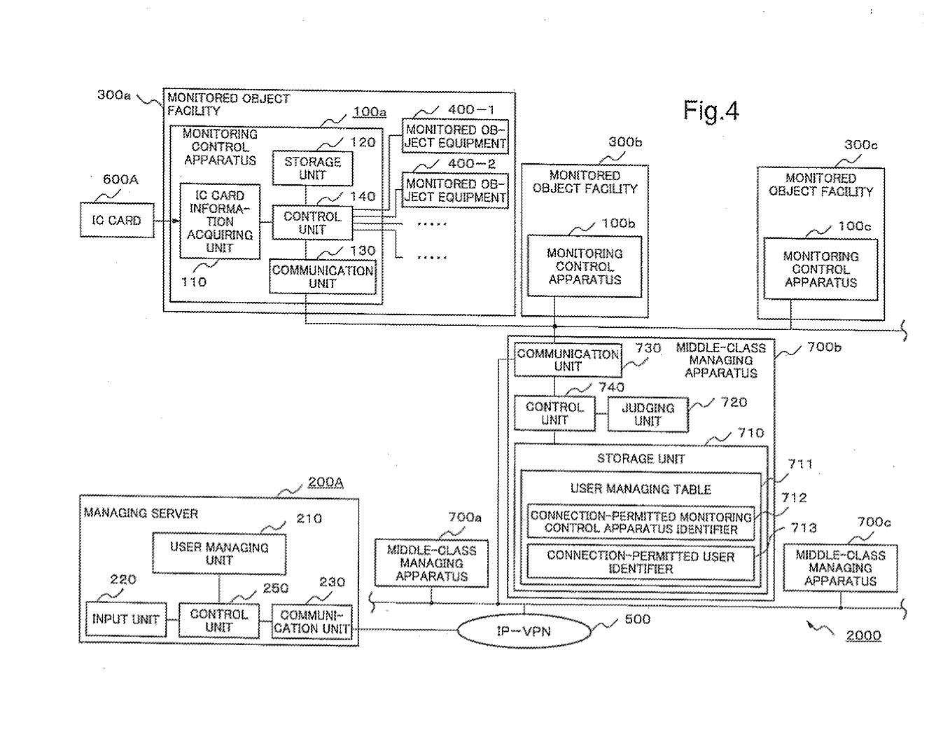

Next, a monitoring system according to a second exemplary embodiment of the present invention will be described. FIG. 4 shows a configuration of the monitoring system according to the second exemplary embodiment of the present invention.

As shown in FIG. 4, a monitoring system 2000 includes the monitoring control apparatus 100, a managing server 200A and middle-class managing apparatuses 700a, 700b and 700c. Here, similarly to the description of the first exemplary embodiment, the middle-class managing apparatuses 700a, 700b and 700c are collectively called as a middle-class managing apparatus 700 as far as it is not necessary to identify and explain each of the middle-class managing apparatuses 700a, 700b and 700c in particular.

The second exemplary embodiment will be compared with the first exemplary embodiment in the following. A different point between the first and the second exemplary embodiments is that the monitoring system 1000 according to the first exemplary embodiment does not includes the middle-class managing apparatus 700, but the monitoring system 2000 according to the second exemplary embodiment includes the middle-class managing apparatus 700. Moreover, another different point is that the managing server 200 includes the judging unit 240 according to the first exemplary embodiment, but the managing server 200A does not include the judging unit according to the second exemplary embodiment.

The monitoring control apparatus 100, the managing server 200A and the middle-class managing apparatus 700 are connected each other in order to communicate each other through IP-VPN 500.

Each constituent of the monitoring system 2000 according to the second exemplary embodiment will be described specifically in the following. Here, a constituent, which is the same as the constituent according to the first exemplary embodiment, is assigned the same code as one according to the first exemplary embodiment, and its description is omitted for convenience.

A configuration of the monitoring control apparatus 100 is the same as one according to the first exemplary embodiment. However, a different point is that the monitoring control apparatus 100 according to the first exemplary embodiment connects with the managing server 200, but the monitoring control apparatus 100 according to the second exemplary embodiment connects with the middle-class managing apparatus 700. For this reason, the second exemplary embodiment is different from the first exemplary embodiment in functions of the IC card information acquiring unit 110 and the control unit 140 in particular.

First, the IC card information acquiring unit 110 will be described specifically. That is, an IC card 600A can be attached to the IC card information acquiring unit 110. The IC card 600A stores, at least, middle-class connection information (for example, an IP address and a node ID of the middle-class managing unit 700) for connecting with the middle-class managing apparatus 700. In contrast, the IC card 600 according to the first exemplary embodiment stores, at least, the connection information (for example, the IP address and the node ID of the managing server 200) for connecting with the managing server 200. Similarly to the first exemplary embodiment, it may be preferable that the IC card 600A stores the user identifier for identifying the user of the monitoring control apparatus 100 in addition to the middle-class connection information.

When the IC card 600A is attached to the IC card information acquiring unit 110, the IC card information acquiring unit 110 acquires various information stored in the IC card 600A. This process is the same as one according to the first exemplary embodiment. That is, in the case that the IC card 600A stores the middle-class connection information, the IC card information acquiring unit 110 acquires the middle-class connection information. In the case that the IC card 600A stores the middle-class connection information and the user identifier, the IC card information acquiring unit 110 acquires the middle-class connection information and the user identifier.

Next, the control unit 140 will be described. In the case that the IC card information acquiring unit 110 acquires the middle-class connection information, the control unit 140 acquires, for example, the IP address of the middle-class managing apparatus 700, which is a connection destination, as the middle-class connection information. Then, the control unit 140 connects with the middle-class managing apparatus 700 via the communication unit 130 on the basis of the acquired middle-class connection information (the IP address of the middle-class managing apparatus 700) to communicate with the middle-class managing apparatus 700. In the case that the IC card 600A stores the middle-class connection information and the user identifier, the IC card information acquiring unit 110 acquires the middle-class connection information and the user identifier, and afterward the control unit 140 connects with the middle-class managing apparatus 700 via the communication unit 130 on the basis of the acquired connection information to communicate with the middle-class managing apparatus 700, and then sends the user identifier to the middle-class managing apparatus 700.

Here, the monitoring control apparatus identifier is registered beforehand in the storage unit 120. The monitoring control apparatus identifier, which is used for identifying the monitoring control apparatus 100, is serial number which is assigned each above-mentioned monitoring control apparatus 100. The above-mentioned serial number, which the user or the set-upper of the monitoring control apparatus 100 can set in advance, can be used as a password. The monitoring control apparatus identifier is sent to the manager of the managing server 200A in advance, and is also stored in the user managing unit 210 of the managing server 200A.

It may be preferable that the control unit 140 connects with the middle-class managing apparatus 700 via the communication unit 130 on the basis of the acquired middle-class connection information on the middle-class managing apparatus 700 to communicate with the middle-class managing apparatus 700, and afterward sends the monitoring control apparatus identifier in addition to the user identifier to the middle-class managing apparatus 700.

While the communication connection between the monitoring control apparatus 100 and the managing server 200 is maintained through transfer by the middle-class managing apparatus 700, the control unit 140 sends the result of monitoring the monitored object equipment 400 to the managing server 200A.

Next, a configuration of the middle-class managing apparatus 700 will be described. The middle-class managing apparatus 700 transfers the communication between the monitoring control apparatus 100 and the managing server 200A. The middle-class managing apparatus 700 includes a storage unit 710, a judging unit 720, a communication unit 730 and a control unit 740.

The storage unit 710 stores various information. The storage unit 710 includes an user managing table 711. Here, the user managing table according to the present invention is corresponding to the user managing unit 210 of the managing server 200 according to the first exemplary embodiment. In contrast, according to the second exemplary embodiment, the user managing table of the present invention is corresponding to not the user managing unit 210 of the managing server 200 but the user managing table 711 of the middle-class managing apparatus 700.

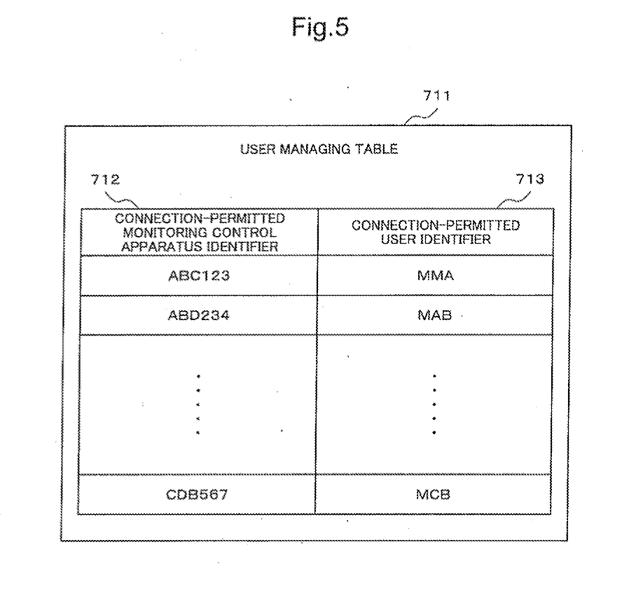

FIG. 5 shows an example of structure of the user managing table. As shown in FIG. 5, the user managing table 711 stores a connection-permitted monitoring control apparatus identifier 712 and a connection-permitted user identifier 713 which are associated each other. Here, the connection-permitted monitoring control apparatus identifier 712 is corresponding to connection-permitted monitoring apparatus identifying information according to the present invention. Moreover, the connection-permitted user identifier 713 is corresponding to connection permission identifying information according to the present invention.

The connection-permitted monitoring control apparatus identifier 712 is used for identifying the monitoring control apparatus 100 which an user (permitted user), who is permitted to connect with the managing server 200A, can use. Moreover, the connection-permitted monitoring control apparatus identifier 712 is a partial copy of the monitoring control apparatus identifiers 213 which are stored in the user managing unit 210 of the managing server 200A. That is, the user managing unit 210 stores information on the monitoring control apparatuses 100 which can be used in a whole of the monitoring system 2000. In contrast, the user managing table 710 stores information on not the monitoring control apparatuses 100 which can be used in a whole of the monitoring system 2000, but the monitoring control apparatuses 100, which the user is permitted to connect with, per the middle-class managing apparatus 700.

The connection-permitted user identifier 713 is information on the permitted user, who is permitted to connect with the managing server 200A, among the users of the monitoring control apparatus 100. Moreover, the connection-permitted user identifier 713 is a partial copy of the user identifiers 214 which are stored in the user managing unit 210 of the managing server 200A. That is, the user managing unit 210 stores the user identifier 214 as the information on the permitted user which a whole of the monitoring system 2000 can use. In contrast, the user managing table 710 stores information on not the permitted user who is permitted per a whole of the monitoring system 2000, but the permitted user who is permitted per the middle-class managing apparatus 700.

The judging unit 720 judges whether the user identifier sent by the monitoring control apparatus 100 exists in the connection-permitted user identifiers 713. Moreover, in the case that the monitoring control apparatus identifier, which is sent by the monitoring control apparatus 100, in addition to the user identifier is received, it may be preferable that the judging unit 720 judges whether the monitoring control apparatus identifier, which is sent by the monitoring control apparatus 100, is coincident with the connection-permitted monitoring control apparatus identifier 712.

The communication unit 730, which connects with IP-VPN 500, communicates with the monitoring control apparatus 100 and the managing server 200A through IP-VPN 500.

The control unit 740 controls a whole of the middle-class managing apparatus 700. In the case that the judging unit 720 judges that the user identifier, which is sent by the monitoring control apparatus 100, exists in the connection-permitted user identifiers 713, the control unit 740 transfers the communication between the monitoring control apparatus 100 and the managing server 200A. Moreover, in the case that the monitoring control apparatus identifier, which is sent by the monitoring control apparatus 100, in addition to the user identifier is also received, it may be preferable that the control unit 740 transfers the communication between the monitoring control apparatus 100 and the managing server 200A when the judging unit 720 judges that the user identifier exists in the connection-permitted user identifiers 713 and the monitoring control apparatus identifier exists in the connection-permitted monitoring control apparatus identifiers 712.

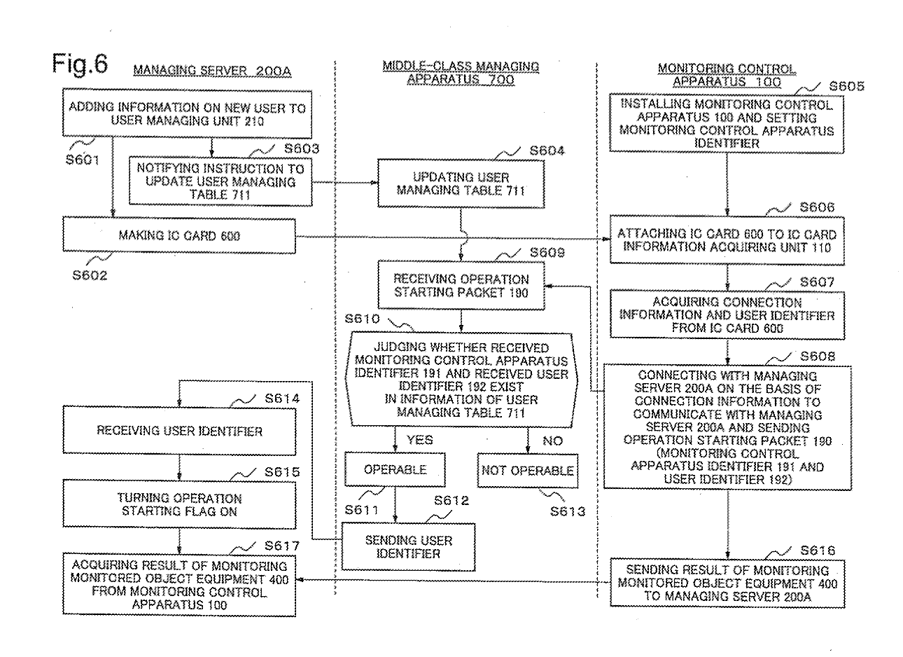

Next, an operation of the monitoring system according to the second exemplary embodiment of the present invention will be described. FIG. 6 is an explanatory diagram showing the operation of the monitoring system according to the second exemplary embodiment of the present invention.

Here, a case that a new monitoring control apparatus 100 is set up is assumed. First, the managing server 200 acquires information on a new user of the monitoring control apparatus 100 which is set up, and adds the information to the user managing unit 210 by use of the input unit 220, and updates information on the user (S601). At this time, a manager of the managing server 200A acquires the monitoring control apparatus identifier, which is set by the user or the set-upper of the monitoring control apparatus 100 optionally, from the user and the set-upper of the monitoring control apparatus 100.

Next, the manager of the managing server 200A makes the IC card 600A on the basis of the information which is stored in the user managing unit 210 (S602). The IC card 600A stores the middle-class connection information (the IP address of the middle-class managing apparatus 700 is exemplified) for connecting with the middle-class managing apparatus 700, and the connection information 215 and the user identifier 214, which are corresponding to the new user, among data stored in the user managing unit 210. The IC card 600A is delivered, for example, by the operator of the monitoring system 1000 or the manager of the managing server 200A to the user of the monitoring control apparatus 100.

Moreover, the managing server 200A notifies the middle-class managing apparatus 700 of an instruction to update the user managing table 711 (S603). At this time, the managing server 200A sends the user identifier of the new user and the monitoring control apparatus identifier, which the new user uses, to the middle-class managing apparatus 700. Here, it may be preferable that not only the information on the new user and the monitoring control apparatus which is set up newly but also the information which is corresponding to the user managing table 711 of the middle managing apparatus 700 are embedded in a packet by the managing server 200A, and the packet is sent to the middle-class managing apparatus 700 by the managing server 200A. At this time, the managing server 200A sends each information in the unicast form only to the middle-class managing apparatus 700 with which the newly-added monitoring control apparatus 100 connects.

Next, the middle-class managing apparatus 700 updates the user managing table 711 through adding the user identifier of the new user and the monitoring control apparatus identifier, which the new user uses, to the user managing table 711 according to the instruction issued by the managing server 200A (S604).

Meanwhile, the user sets up the monitoring control apparatus 100 in the monitored object facility 300 and connects the monitored object equipment 400 with the monitoring control apparatus 100 (S605). The user or the set-upper of the monitoring control apparatus 100 sets the monitoring control apparatus identifier optionally, and informs the manager of the managing server 200A of the monitoring control apparatus identifier. When the user attaches the IC card 600A to the IC card information acquiring unit 110 (S606), the IC card information acquiring unit 110 acquires the connection information and the user identifier from the IC card 600A (S607).

Next, the communication unit 130 of the monitoring control apparatus 100 connects with the middle-class managing apparatus 700 through IP-VPN 500 on the basis of the middle-class connection information (the IP address of the middle-class managing apparatus 700) to communicate with the middle-class managing apparatus 700. Then, the communication unit 130 of the monitoring control apparatus 100 embeds the user identifier, which is stored in the IC card 600A, and the monitoring control apparatus identifier, which is set in advance, in a start notifying packet, and sends the operation starting packet to the middle-class managing apparatus 700 (S608).

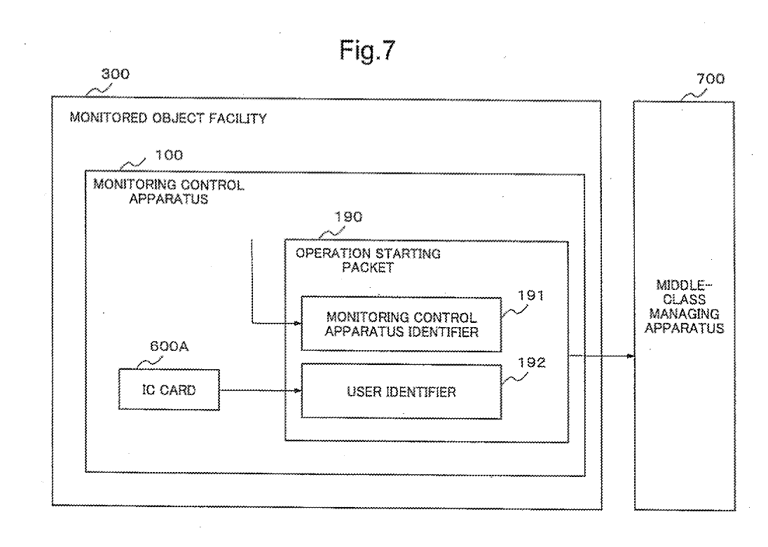

Here, the operation starting packet will be described. FIG. 7 is an explanatory diagram showing the operation starting packet. As shown in FIG. 7, an operation starting packet 190 is generated in the monitoring control apparatus 100. The operation starting packet 190 includes a monitoring control apparatus identifier 191 and an user identifier 192. As mentioned above, the monitoring control apparatus identifier 191 is set beforehand in the monitoring control apparatus 100 by the user and the set-upper of the monitoring control apparatus 100. The user identifier 192 is acquired from the IC card 600A by the IC card information acquiring unit 110. The control unit 140 generates the operation starting packet 190, and sends the operation starting packet 190 to the middle-class managing apparatus 700 via the communication unit 130.

Going back to FIG. 6, when the communication unit 730 of the middle-class managing apparatus 700 receives the operation starting packet 190 (S609), the judging unit 720 of the middle-class managing apparatus 700 judges whether the received user identifier 192 and the received monitoring control apparatus identifier 191 exist in the connection-permitted user identifiers 713 and the connection-permitted monitoring control apparatus identifiers 712 respectively in the user managing table 711 (S610).

In the case that the user identifier 192 and the monitoring control apparatus identifier 191 exist in the connection-permitted user identifiers 713 and the connection-permitted monitoring control apparatus identifiers 712 respectively (YES in S610), the control unit 740 of the middle-class managing apparatus 700 judges to be operable (S611), and sends the user identifier 192 to the managing server 200A (S612). On the other hand, in the case that the user identifier 192 and the monitoring control apparatus identifier 191 do not exist in the connection-permitted user identifiers 713 and the connection-permitted monitoring control apparatus identifiers 712 respectively (NO in S610), the control unit 740 of the middle-class managing apparatus 700 judges to be not operable (S613), and does not carry out any process afterward. In this case, it may be preferable that the middle-class managing apparatus 700 notifies the monitoring control apparatus 100 of the monitoring system 2000 being not operable.

Next, the managing server 200A receives the user identifier 192 from the middle-class managing apparatus 700 (S614), and sets the operation starting flag 216 to the ON state (S615). At this time, the managing server 200A and the monitoring control apparatus 100 are connected each other to communicate each other by transfer of the middle-class managing apparatus 700.

While the operation starting flag 216 is turned ON, the communication unit 130 of the monitoring control apparatus 100 sends the result of monitoring the monitored object equipment 400 to the managing server 200A (S616), and then the control unit 250 of the managing server 200A acquires the monitoring result through the communication unit 230 (S617). As mentioned above, the managing server 200A can acquire the result of the monitoring control apparatus 100 monitoring the monitored object equipment 400.

While it is exemplified in FIG. 6 and FIG. 7 that the monitoring control apparatus identifier 191 and the user identifier 192 are embedded in a operation starting packet 190, it may be preferable that the monitoring control apparatus identifier 191 is not embedded in the operation starting packet 190. In this case, the monitoring control apparatus 100 sends the operation starting packet 190, which embeds only the user identifier 192, to the middle-class managing apparatus 700, instead of the process of S608 in FIG. 5. Moreover, the judging unit 720 judges whether the received user identifier 192 exists in the connection-permitted user identifiers 713 in the user managing table 711, instead of the process of S610 in FIG. 6. In the case that the user identifier 192 exists in the connection-permitted user identifiers 713, the control unit 740 of the middle-class managing apparatus 700 judges to be operable, and then sends the user identifier 192 to the managing server 200A. On the other hand, in the case that the user identifier 192 does not exist in the connection-permitted user identifiers 713, the control unit 740 of the middle-class managing apparatus 700 judges to be not operable, and does not carry out any process afterward.

As mentioned above, the monitoring system 2000 according to the second exemplary embodiment of the present invention includes the monitoring control apparatus 100, the managing server 200A and the middle-class managing apparatus 700. The middle-class managing apparatus 700 transfers the communication between the monitoring control apparatus 100 and the managing server 200A. Moreover, the monitoring control apparatus 100 includes the IC card information acquiring unit 110 which acquires information from the IC card 600A. The IC card 600A stores the middle-class connection information for connecting with the middle-class managing apparatus 700 and the user identifier for identifying the user of the monitoring control apparatus 100. The IC card information acquiring unit 110 acquires the middle-class connection information and the user identifier from the IC card 600A. In the case that the IC card information acquiring unit 110 of the monitoring control apparatus 100 acquires the connection information and the user identifier from the IC card 600A, the monitoring control apparatus 100 connects with the middle-class managing apparatus 700 on the basis of the middle-class connection information to communicate with the middle-class managing apparatus 700, and sends the user identifier to the middle-class managing apparatus 700. Moreover, the middle-class managing apparatus 700 includes the user managing table 711 and the judging unit 720. The user managing table 711 stores beforehand the connection-permitted user identifier which is related to the user who is permitted to connect with the managing server 200A among the users of the monitoring control apparatus 100. The judging unit 720 judges whether the user identifier, which is sent by the monitoring control apparatus 100, exists in the connection-permitted user identifiers 713. In the case that the judging unit 720 of the middle-class managing apparatus 700 judges that the user identifier, which is sent by the monitoring control apparatus 100, exists in the connection-permitted user identifiers 713, the middle-class managing apparatus 700 transfers the communication between the monitoring control apparatus 100 and the managing server 200A.

As mentioned above, the monitoring control apparatus 100 can read and acquire the middle-class connection information easily from the IC card 600 with no necessity of holding internally the middle-class connection information which is used for connecting with the middle-class managing apparatus 700. For this reason, according to the art of the present invention, it is possible to connect the monitoring control apparatus 100 easily with the destination with no necessity of setting the destination inside the monitoring control apparatus 100. Moreover, since it is possible to acquire the middle-class connection information only through attaching the IC card 600A to the IC card information acquiring unit 110, it is unnecessary that a manufacturer sets the middle-class connection information for each monitoring control apparatus 100 at a time of manufacturing the monitoring control apparatus 100. As a result, it is possible to reduce the work load. Only the user identifier and the middle-class connection information among information on the user are stored in the IC card 600, and all other information is managed by the managing server 200. As a result, even if the IC card 600 is lost, it is possible to prevent important information on the user (for example, name, address, or the like) from leaking.

According to the monitoring system 2000 of the second exemplary embodiment of the present invention, the monitoring control apparatus 100 furthermore has the monitoring control apparatus identifier for identifying the monitoring control apparatus 100. Moreover, the middle-class managing apparatus 700 includes the user managing table 711. The connection-permitted user identifier 713 and the connection-permitted monitoring control apparatus identifier 712 are associated each other to be stored in the user managing table 711 in advance. The connection-permitted monitoring control apparatus identifier 712 is used for identifying the monitoring control apparatus 100 which the permitted user can use. The judging unit 720 judges whether the user identifier, which is sent by the monitoring control apparatus 100, exists in the connection-permitted user identifiers 713, and judges whether the monitoring control apparatus identifier, which is sent by the monitoring control apparatus 100, exists in the connection-permitted monitoring control apparatus identifiers. In the case that the judging unit 720 judges that the user identifier exists in the connection-permitted user identifiers 713, and judges that the monitoring control apparatus identifier exists in the connection-permitted monitoring control apparatus identifiers 712, the middle-class managing apparatus 700 transfers the communication between the monitoring control apparatus 100 and the managing server 200A.

As mentioned above, the judging unit 720 identifies the user and the monitoring control apparatus 100, that request the connection with the managing server 200A, by use of the user identifier and the monitoring control apparatus identifier. As a result, the managing server 200A can acquire surely the monitoring result which is issued by the monitoring control apparatus 100 of the user who is permitted to connect with the managing server 200A. Moreover, the managing server 200A can restrict an access from the user and the monitoring control apparatus 100 that are not permitted to connect with the managing server 200A.

### Third Exemplary Embodiment of the Present Invention

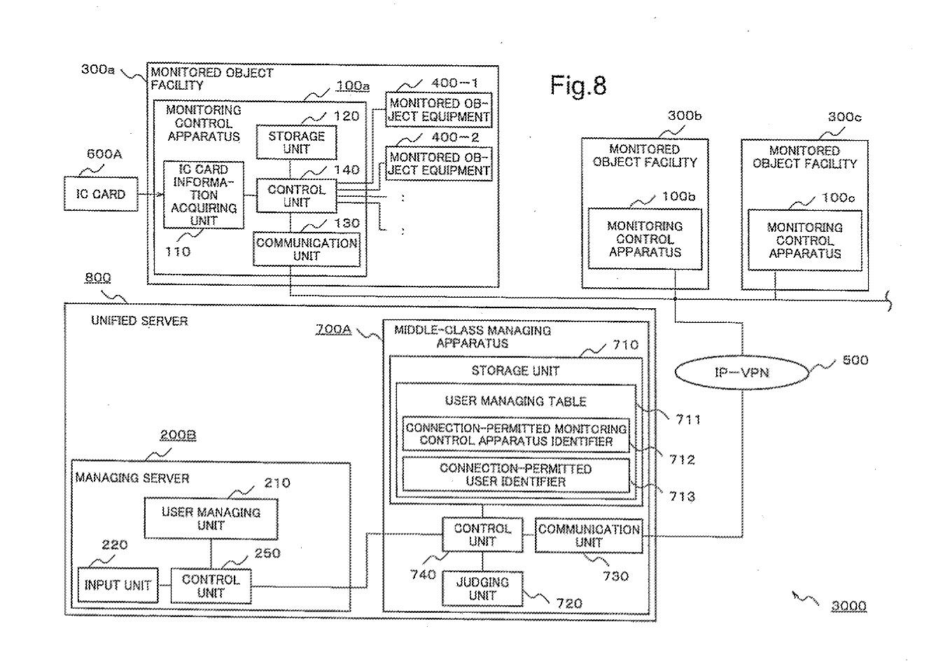

Next, a monitoring system 3000 according to a third exemplary embodiment of the present invention will be described. FIG. 8 shows a configuration of the monitoring system 3000 according to the third exemplary embodiment of the present invention.

As shown in FIG. 8, the monitoring system 3000 includes the monitoring control apparatus 100 and an unified server 800. The unified server 800 includes a managing server 200B and the middle-class managing apparatus 700A.

The monitoring system 3000 according to the third exemplary embodiment is the same in the basic configuration as the monitoring system 2000 according to the second exemplary embodiment. However, there is a different point if the second and the third exemplary embodiments are compared. That is, while the managing server 200A and the middle-class managing apparatus 700 are connected each other through IP-VPN 500 according to the second exemplary embodiment, the managing server 200B and the middle-class managing apparatus 700A are included in one apparatus, that is, in the unified managing server 800 according to the third exemplary embodiment. Therefore, the managing server 200B and the middle-class managing apparatus 700A are connected each other through not IP-VPN 500 but LAN or the like. The managing server 200B does not include the communication unit differently from the second exemplary embodiment.

Since other detailed constituents and operations are the same as ones according to the second exemplary embodiment, specific description on other detailed constituents and operations is omitted. In this case, the middle-class managing apparatus 700A of the unified server 800 may be called an upper apparatus, and the user managing unit 210 of the managing server 200B may be called an user managing server, and the control unit 250 of the managing server 200B may be called an upper system in some case.

The present invention has been described according to the embodiment. Since the embodiment is exemplary, it may be preferable that various changes, additions, deletions and combinations are added to the embodiment mentioned above without departing from the spirit and scope of the present invention. It is understood by a person skilled in the art that the modified embodiment, which includes the various changes, additions, deletions and combinations, is included in the present invention.

While the monitoring system and the monitoring method have been described specifically according to the first to the third exemplary embodiments, the present invention is not limited to the monitoring system and the monitoring method. It may be preferable that the present invention is a program which is used in the monitoring system and which carries out the monitoring method, and a storage medium to store the program.

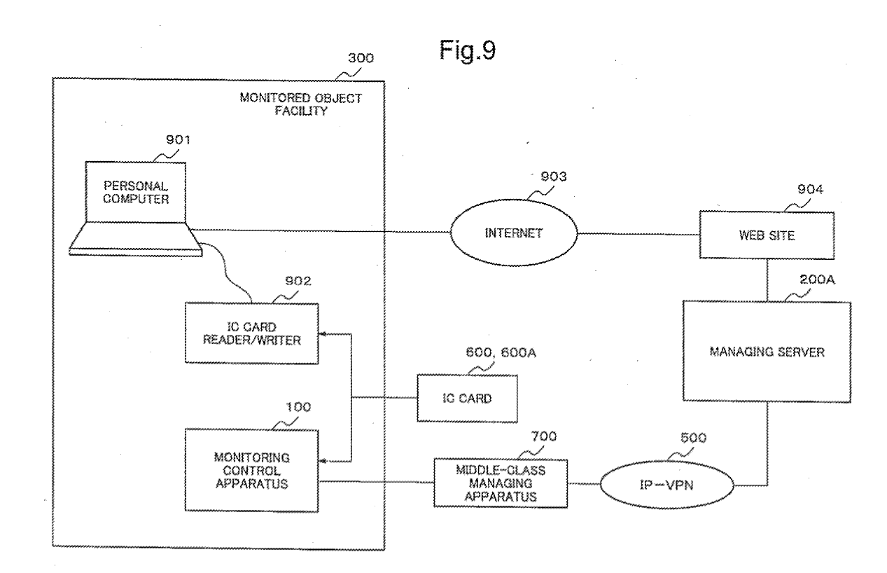

FIG. 9 shows a configuration with which the user of the monitoring control apparatus checks a management state which is managed by the managing server. FIG. 9 shows a configuration which is corresponding to the monitoring system 2000 according to the second exemplary embodiment. Since the main difference in the configuration of the second exemplary embodiment from ones of the first and the third embodiments is whether the middle-class managing apparatus is installed, and where the middle-class managing apparatus is installed, the configuration shown in FIG. 9 is applicable to the monitoring system according to the first and the third exemplary embodiments.

As shown in FIG. 9, PC (Personal Computer) 901 and an IC card reader/writer 902, which connects with PC 901, together with the monitoring control apparatus 100 are installed in the monitored object facility 300. PC 901 is connected with the internet 903. The managing server 200A is connected with a Web site 904. PC 901 and the Web site 904 are connected each other in order to communicate each other through the internet 903.

The managing server 200A provides the Web site 904 with the result of the monitoring control apparatus 100 monitoring the monitored object equipment 400, accounting information and personal information such as the name of the user.

The user of the monitoring control apparatus 100 accesses the Web site 904 from PC 901 through the internet 903. The Web site 904, which is dedicated for the user of the monitoring control apparatus 100, uses the user identifier, which is stored in the IC card 600A, for authentication. A predetermined password, which is set in advance for the authentication, is managed within the managing server 200A.

The user inserts the IC card 600A into the IC card reader/writer 902, and input the predetermined password which is set in advance in the managing server 200A. Then, the managing server 200A judges whether the user identifier and the password, which are stored in the IC card 600A, are coincident with ones managed within the managing server 200A. In the case of coincidence, the user can read contents of the Web site 904 which is dedicated for the user. As a result, the user can read the result of the monitoring control apparatus 100 monitoring the monitored object equipment 400, the accounting information and the personal information such as the name of the user through the Web site 904.

Moreover, the managing server 200A provides the Web site 904 with an updated file of software for operating the monitoring control apparatus 100. The user can store, for example, the updated file of the software temporarily in the IC card 600A. Through the user attaching the IC card 600A to the IC card information acquiring unit 110 of the monitoring control apparatus 100, it is possible to apply the updated file, which is stored temporarily in the IC card 600A, to the monitoring control apparatus 100.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A monitoring system, comprising:
a monitoring apparatus which monitors a monitored object equipment; and
a managing server which manage a result of the monitoring apparatus monitoring the monitored object equipment, wherein
the monitoring apparatus includes an information acquiring unit to acquire connection information, which is used for connecting with the managing server, from an information storing medium which stores the connection information, wherein
in the case that the information acquiring unit acquires the connection information from the information storing medium, the monitoring apparatus connects with the managing server on the basis of the connection information to communicate with the managing server, and then sends the monitoring result to the managing server, and wherein
the managing server acquires the monitoring result while the communication connection with the monitoring apparatus is maintained.

2. The monitoring system according to claim 1, wherein
the information storing medium stores identification information, which identifies an user of the monitoring apparatus, in addition to the connection information, wherein
the managing server comprises:
an user table to store beforehand connection permission identifying information which is corresponding to information on an user who is permitted to connect with the managing server among the users of the monitoring apparatus; and
a judging unit to judge whether the identification information, which is sent by the monitoring apparatus, exists in the connection permission identifying information, and wherein
in the case that the judging unit judges that the identification information exists in the connection permission identifying information, the managing server acquires the monitoring result.

3. The monitoring system according to claim 1, wherein
the monitoring system includes a middle-class managing apparatus furthermore, wherein
the monitoring apparatus includes a information acquiring unit to acquire middle-class connection information for connecting with the middle-class managing apparatus, and the identification information to identify the user of the monitoring apparatus from an information storing medium which stores the middle-class connection information and the identification information, wherein
in the case that the information acquiring unit acquires the middle-class connection information from the information storing medium, the monitoring apparatus connects with the middle-class managing apparatus on the basis of the middle-class connection information to communicate with the middle-class managing apparatus, and then sends the monitoring result to the middle-class managing apparatus, wherein
the middle-class managing apparatus comprises:
an user table to store beforehand connection permission identifying information which is corresponding to information on the user who is permitted to connect with the managing server among the users of the monitoring apparatus; and
a judging unit to judge whether the identification information, which is sent by the monitoring apparatus, exists in the connection permission identifying information, and wherein
in the case that the judging unit judges that the identification information exists in the connection permission identifying information, the middle-class managing apparatus transfers communication between the monitoring apparatus and the managing server.

4. The monitoring system according to claim 3, wherein
the monitoring apparatus holds monitoring apparatus identifying information to identify the monitoring apparatus, wherein
the middle-class managing apparatus makes the connection permission identifying information and connection-permitted monitoring apparatus identifying information for identifying the monitoring apparatus, which the permitted user can use, associated each other and makes the associated connection permission identifying information and the associated connection-permitted monitoring apparatus identifying information stored in the user table in advance, wherein
the middle-class managing apparatus includes a judging unit which judges whether the identification information, which is sent by the monitoring apparatus, exists in the connection permission identifying information, and judges whether the monitoring apparatus identifying information, which is sent by the monitoring apparatus, exists in the connection-permitted monitoring apparatus identifying information, and wherein
in the case that the judging unit judges that the identification information exists in the connection permission identifying information, and judges that the monitoring apparatus identifying information exists in the connection-permitted monitoring apparatus identifying information, the middle-class managing apparatus transfers the communication between the monitoring apparatus and the managing to server.

5. The monitoring system according to claim 3, wherein
the monitoring apparatus and the middle-class managing apparatus are included in one apparatus.

6. A monitoring apparatus which monitors a monitored object equipment, wherein
a result of the monitoring apparatus monitoring the monitored object equipment is managed by a managing server, wherein
the monitoring apparatus includes an information acquiring unit to acquire connection information, which is used for connecting with the managing server, from an information storing medium which stores the connection information, and wherein
in the case that the information acquiring unit acquires the connection information from the information storing medium, the monitoring apparatus connects with the managing server on the basis of the connection information to communicate with the managing server, and then sends the monitoring result to the managing server.

7. A monitoring method to monitor a monitored object equipment by use of a system which includes a monitoring apparatus to monitor the monitored object equipment, and a managing server to manage a result of the monitoring apparatus monitoring the monitored object equipment, comprising:
acquiring by the monitoring apparatus connection information, which is used for connecting with the managing server, from an information storing medium which stores the connection information;
connecting by the monitoring apparatus with the managing server on the basis of the connection information to communicate with the managing server, in the case that the information acquiring unit acquires the connection information from the information storing medium, and sending by the monitoring apparatus the monitoring result to the managing server; and
acquiring by the managing server the monitoring result while the communication connection between the managing server and the monitoring apparatus is maintained.

8. A program, which is applied to a system including a monitoring apparatus to monitor a monitored object equipment, and a managing server to manage a result of the monitoring apparatus monitoring the monitored object equipment, and which is used for monitoring the monitored object equipment, carries out:
acquiring by the monitoring apparatus connection information, which is used for connecting with the managing server, from an information storing medium which stores the connection information;
connecting by the monitoring apparatus with the managing server on the basis of the connection information to communicate with the managing server, in the case that the information acquiring unit acquires the connection information from the information storing medium, and sending by the monitoring apparatus the monitoring result to the managing server; and
acquiring by the managing server the monitoring result while the communication connection between the managing server and the monitoring apparatus is maintained.
